(19) United States
(12) Patent Application Publication
(10) Pub. No.: US 2010/0198583 A1
(43) Pub. Date: Aug. 5, 2010

(54) INDICATING METHOD FOR SPEECH RECOGNITION SYSTEM

(75) Inventors: Chen-Wei Su, Taipei City (TW); Chun-Ping Fang, Taipei City (TW); Min-Ching Wu, Taipei City (TW)

Correspondence Address: AIBELIVE CO., LTD., P.O.BOX 108-00403, Taipei, 106, omitted

(73) Assignee: AIBELIVE CO., LTD., Taipei City (TW)

(21) Appl. No.: 12/365,879

(22) Filed: Feb. 4, 2009

(51) Int. Cl. G06F 17/27; G10L 21/06; G10L 15/04

(52) U.S. Cl. 704/9; 704/276; 704/251; 704/E21.019; 704/E15.005

(57) ABSTRACT

The present invention relates to an indicating method for speech recognition system, comprising a multimedia electronic product and a speech recognition device. The steps of this method include: users enter voice commands into a voice input unit and convert these commands into speech signals, which are acquired and stored by a recording unit, converted by a microprocessor into a volume indicating oscillogram, and then displayed by a display module. At the same time, compliance with speech recognition conditions will be decided in that process. That is to say, an indicating module is used for diagram, letter or color marking or speech indication according to volume indicating oscillogram, followed by playing over a sound amplifying unit, so that users can understand the voice input status and adjust the volume to fulfill voice command operations virtually through voice indication, explanations in graphs or letters and other interactive guidance, together with audio indication oscillogram, thus further enhancing speech recognition rate and avoiding such problems and deficiencies as distortions related to abnormal and poor sound acquisition or inconvenience for use.

### BACKGROUND OF THE INVENTION

1. Field of the Invention

The present invention provides an indicating method for speech recognition system, more particularly, an indicating method that allows users to get an immediate understanding of input status and adjust the volume to fulfill voice command operations virtually with guidance of acoustic and graphical interfaces together with recording waveforms, thus enhancing speech recognition rate and avoiding abnormal or poor sound acquisition.

2. Description of the Prior Art

Currently in the IT age with Internet beyond boundaries, multimedia audio and video (AV) signals can be transmitted and downloaded in network packets for the purpose of digital AV signal transmissions. These AV signals can be downloaded from legitimate websites and stored in multimedia storage/playing devices including portable disc players, MP3 (or MP4, MP5) players, iPod players, PCs or notebook PCs, and transmitted and played by connecting with sound amplifying devices, such as microphones, loudspeakers, sound boxes or earphones, etc.

However, it is necessary for users to press and touch buttons, knobs or other human-machine interfaces (HMI) of various kinds on the surface of common multimedia storage/playing devices with their fingers before these devices can perform playing and selecting songs or switchover to other items. Only in this way can users conduct more switchovers or selection of play patterns. Undoubtedly, this playing requirement will add to inconvenience and difficulty in use of these devices. Besides, as the multimedia storage/playing devices are designed to occupy less space in compliance with miniaturization requirements, which requires the size of buttons and HMI, etc. to be reduced, as a result, users are liable to undesired touching and make mistakes in entering or selection when they press or touch the buttons of these devices, thus having impact on operating convenience and accuracy.

In addition, to eliminate the disadvantages mentioned above, the persons from the industry concerned invent this speech recognition device, and connect it with multimedia storage/playing devices for storing voice files inside. This enables the device to recognize and analyze the speech signals (microphone sound) inputted by external users by using the recognition module built in the speech recognition device, and then start the multimedia storage/playing device to play the voice files. At the same time, the speech recognition device can achieve the functions of control and operation of selecting, adjusting and switching the contents to be played based on externally inputted speech signals. However, speech signals cannot be virtually entered often due to abnormality of users' microphones (failure, damage or unsuccessful connection, and the volume is set to be too high or low, etc) and their improper use (receiving sounds in a place too faraway or close to microphones) when the speech recognition device identifies and analyzes the externally inputted speech signals. Or, low recognition rate of speech signals or distortions occur as a result of poor sound acquisition due to effect of noisy environment to different degrees, and the problems remain unsolved. This will not only make it rather inconvenient and inefficient to use this device, but also have impact on willingness of users to use it, or bring discomfort to them. Imperceptibly, these things will lead to economic losses which may be too heavy to be estimated, and do not accord with the considerations in economic benefits.

Thus, what the firms involved in this industry need urgently to research and improve is how to solve the problems of reduction in overall added values and increase in costs, which are related to inconvenient use, operating complexity and difficulty resulting from low recognition rate of speech signals or distortions due to abnormality of microphones and poor sound acquisition as users enter speech signals into the speech recognition device for control and operation of selection, adjustment and switchover of the contents to be played by the multimedia storage/playing device.

### SUMMARY OF THE INVENTION

In view of the aforesaid deficiencies and disadvantages, the inventor, after collecting relevant materials, inviting assessments and reviews from various parties, relying on his own experience of many years in this industry and through continuous trials and corrections, has finally invented the method for speech recognition system.

The primary objective of the present invention is to fulfill the function that enables users to enter voice commands into a voice input unit and convert the commands into speech signals, which are acquired and stored by a recording unit, then converted by a microprocessor into a volume indicating oscillogram, and finally displayed by a display module. At the same time, compliance with speech recognition conditions will be decided in that process. Thus, it can make the device rely on an indicating module to mark diagrams, letters or colors, or indicate speeches according to volume indicating oscillogram, followed by playing over a sound amplifying unit, so that users can understand the voice input status and adjust the volume to fulfill voice command operations virtually through speech indication, explanations in graphs or letters and other interactive guidance, together with audio indication oscillogram, and at the same time, avoid such problems and deficiencies as low speech recognition rate or distortions resulting from dysfunction of microphones and poor sound acquisition. In this way, this device can be used simply, easily and quickly, thus improving its functions and effect in overall use.

### BRIEF DESCRIPTION OF THE DRAWINGS

FIG. 1 is a block diagram according to one preferred embodiment of the present invention.

FIG. 2 shows a flow chart of operation according to one preferred embodiment of the present invention.

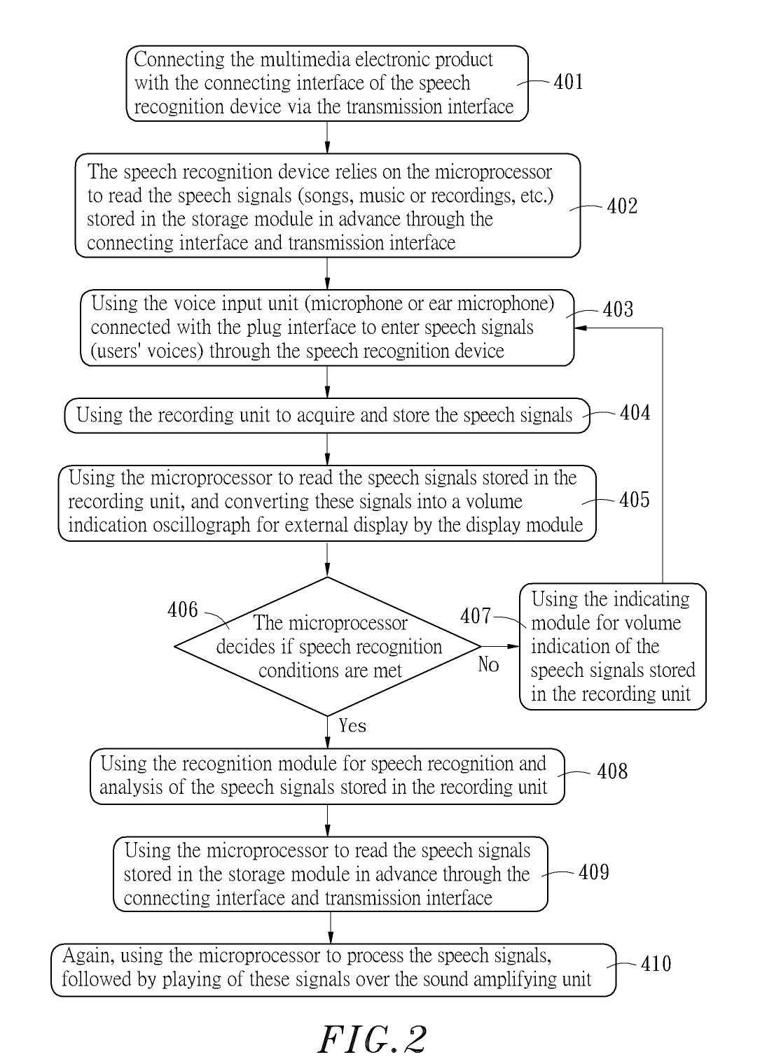

FIG. 3 shows a flow chart of steps for volume indication of voice input signals in the indicating module according to one preferred embodiment of the present invention.

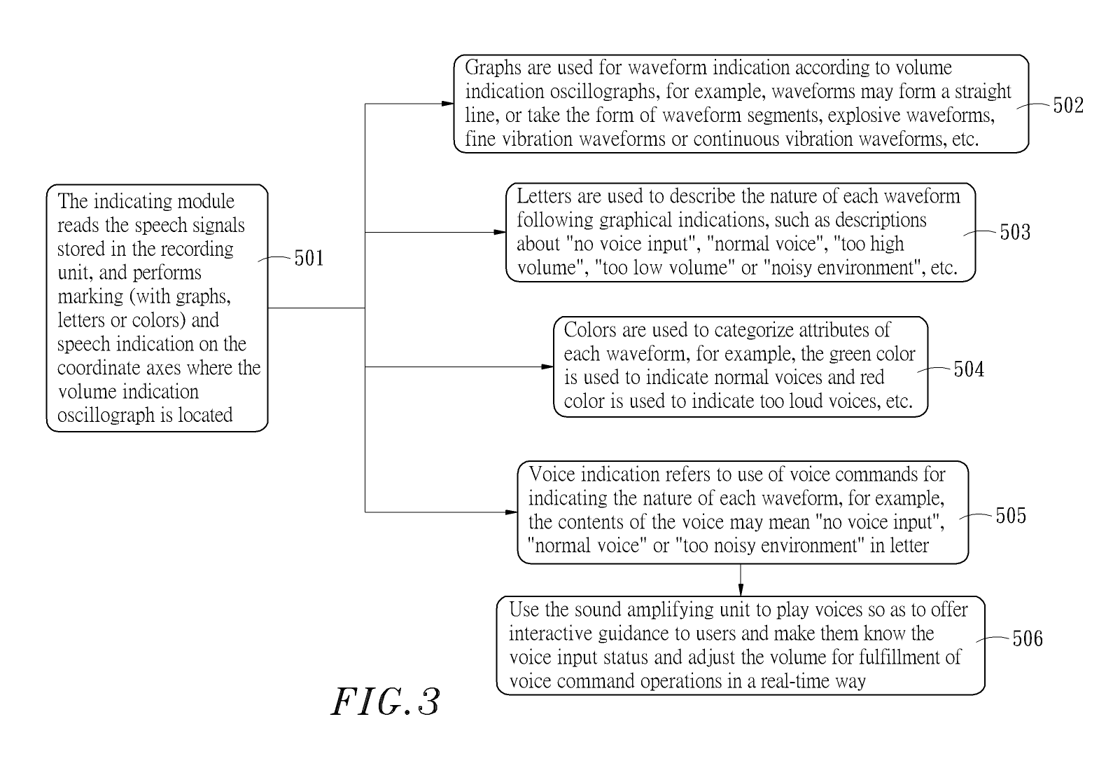

FIG. 4 shows schematically a volume indication waveform of voice input signals in the indicating module according to one preferred embodiment of the present invention.

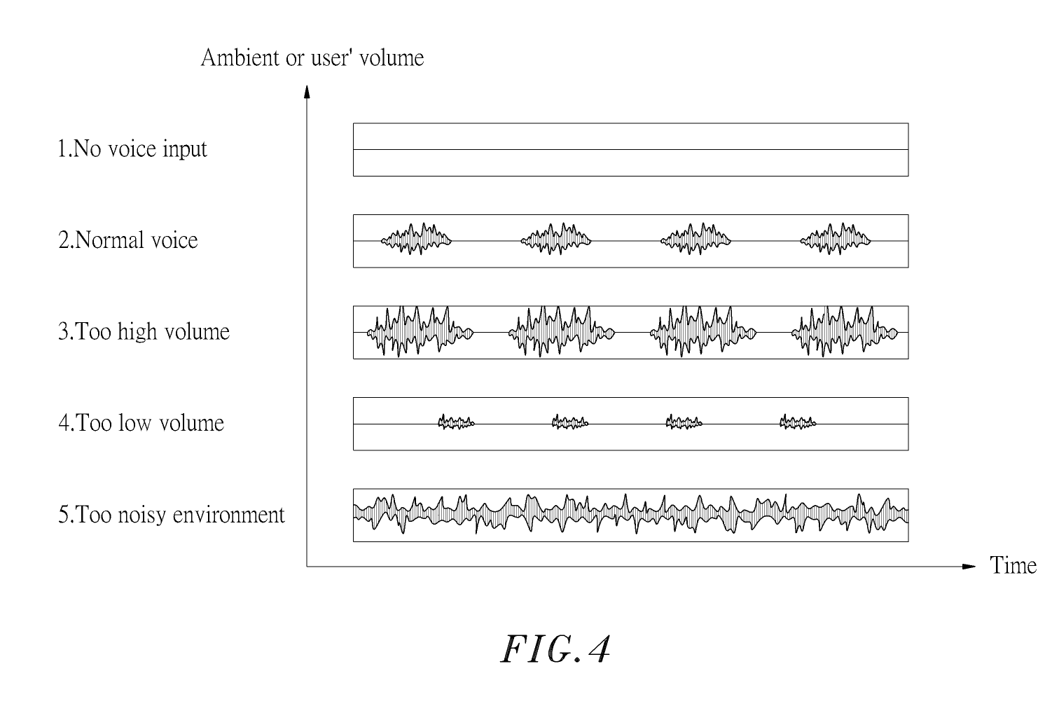

FIG. 5 is a flow chart for steps of analysis of voice input signals in the speech recognition module according to one preferred embodiment of the present invention.

FIG. 6 shows a flow chart for comparison of constructive concept scripts in speech recognition module according to one preferred embodiment of the present invention.

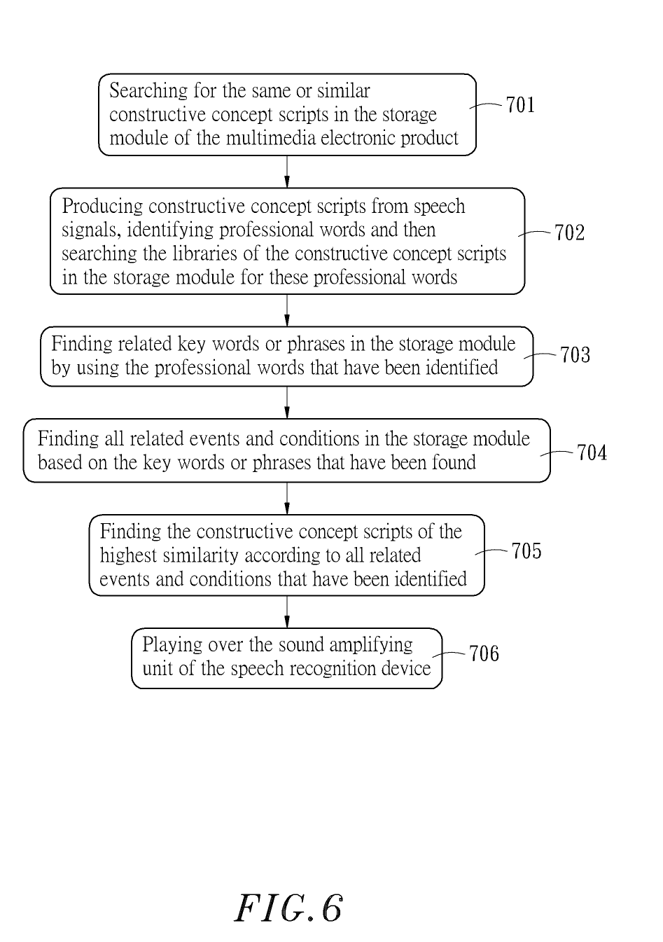

### DETAIL DESCRIPTION OF THE INVENTION

To achieve the objectives and functions stated above as well as the technology and framework adopted in the present invention, an example of the preferred embodiment of the present invention is given to describe its features and functions in detail with reference to the accompanying drawings for the purpose of full understanding.

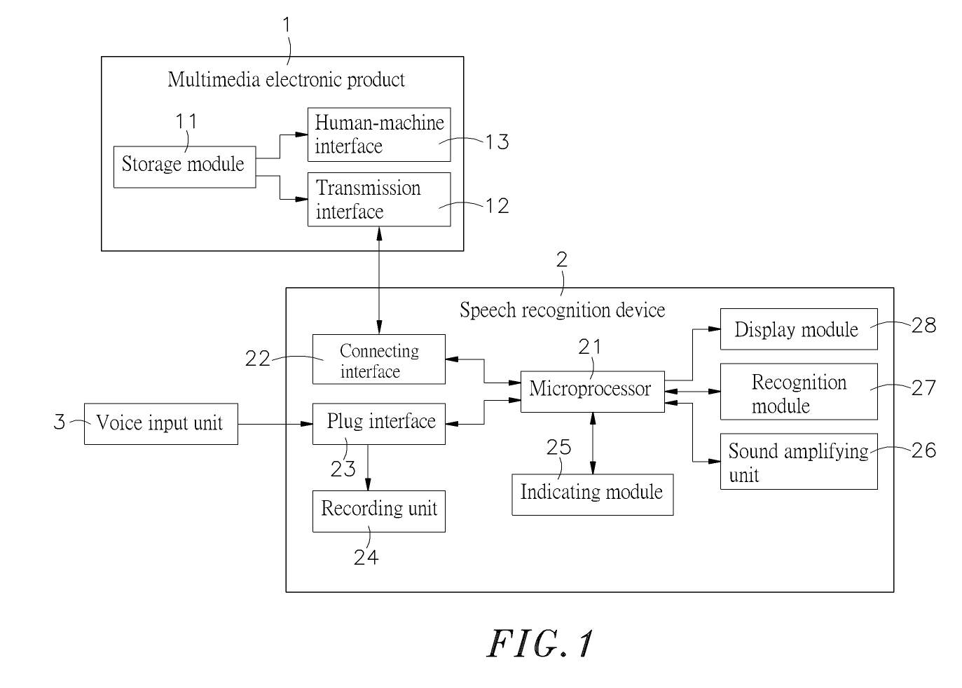

Refer to FIGS. 1˜4, which show that the speech recognition system of the present invention comprises a multimedia electronic product 1 and a speech recognition device 2, wherein

The multimedia electronic product 1 may be an iPod player (digital multimedia player), MP3 player, PC, notebook PC or other electronic product with the multimedia storage/playing function, and is equipped with a storage module 11 for storing audio or video signals inside. Besides, the multimedia electronic product 1 has a transmission interface 12 and an HMI 13 that can execute embedded programs and edit and store signals.

Inside the speech recognition device 2, there is a microprocessor 21 that can perform editing of internal programs and system units of various kinds or communication and processing of input signals. The microprocessor 21 is connected with a connecting interface 22 and a plug interface 23, both of which can be linked with the transmission interface 12 of the multimedia electronic product 1, and the plug interface 23 is further linked with an external voice input unit 3 (e.g. microphone or ear microphone). A recording unit 24 can acquire and store the speech signals from the voice input unit 3, while an indicating module 25 can read the speech signals stored in the recording unit 24 for volume indication and is connected with a sound amplifying unit 26 for outward sound amplification (for example, loudspeaker, sound box or earphone); and a recognition module 27 can read the speech signals stored in the recording unit 24 for the purpose of recognition and analysis. In addition, the microprocessor 21 is connected with a display module 28 that can display the volume indications reflected in the indicating module 25 (such as LCD or panel).

For fabrication of the present invention, the storage module 11 in the multimedia electronic product 1 will be used to store and record multiple speech signals (e.g. songs, music or recordings) in advance and linked with the connecting interface 22 of the speech recognition device 2 via the transmission interface 12. The multimedia electronic product 1 is started by volume indication and speech signals that have been recognized through the connecting interface 22 and transmission interface 12. That is to say, the speech recognition device 2 depends on the recording unit 23 to acquire and store the speech signals (users' voices) inputted from the external voice input unit 3, then uses the microprocessor 21 to convert the speech signals into a volume indication oscillograph, and finally achieve displays by using the display module 28. At the same time, the microprocessor 21 will decide if the speech signals satisfy the speech recognition condition, read the speech signals stored in the recording unit 24 by using the indicating module 25, and achieve volume indication through the sound amplifying unit 26 and display module 28. Or, if the recognition module 27 is used to read the speech signals stored in the recording unit 24 for speech recognition and analysis, the microprocessor 21 will read the speech signals stored in advance in the storage module 11 of the multimedia electronic product 1, perform selection, switch or editing of the speech signals, and play the speech signals externally through the sound amplifying unit 26.

In addition, for voice input, indication and recognition in the present invention, the operation steps include:
(401) connecting the multimedia electronic product 1 with the connecting interface 22 of the speech recognition device 2 via the transmission interface 12;
(402) the speech recognition device 2 relies on the microprocessor 21 to read the speech signals (songs, music or recordings, etc.) stored in the storage module 11 in advance through the connecting interface 22 and transmission interface 12;
(403) using the voice input unit 3 (microphone or ear microphone) connected with the plug interface 23 to enter speech signals (users' voices) through the speech recognition device 2;
(404) using the recording unit 24 to acquire and store the speech signals;
(405) using the microprocessor 21 to read the speech signals stored in the recording unit 24, and convert these signals into a volume indication oscillograph for external display by the display module 28;
(406) the microprocessor 21 decides if speech recognition conditions are met? If not, proceed to step (407); if so, proceed to step (408);
(407) using the indicating module 25 for volume indication of the speech signals stored in the recording unit 24, and then repeat the step (403);
(408) using the recognition module 27 for speech recognition and analysis of the speech signals stored in the recording unit 24;
(409) using the microprocessor 21 to read the speech signals stored in the storage module 11 in advance through the connecting interface 22 and transmission interface 12;
(410) again, using the microprocessor 21 to process the speech signals, followed by playing of these signals over the sound amplifying unit 26.

Additionally, the indicating module 25 is used for volume indication of the speech signals inputted via the voice input unit 3 of the present invention, wherein the operation steps comprise:
(501) the indicating module 25 reads the speech signals stored in the recording unit 24, and performs marking (graphs, letters or colors) and speech indication on the coordinate axes where the volume indication oscillograph is located;
(502) graphs are used for waveform indication according to volume indication oscillographs, for example, waveforms may form a straight line, or take the form of waveform segments, explosive waveforms, fine vibration waveforms or continuous vibration waveforms, etc;
(503) letters are used to describe the nature of each waveform following graphical indications, such as descriptions about “no voice input”, “normal voice”, “too high volume”, “too low volume” or “noisy environment”, etc;
(504) colors are used to categorize attributes of each waveform, for example, the green color is used to indicate normal voices and red color is used to indicate too loud voices, etc;
(505) voice indication refers to use of voice commands for indicating the nature of each waveform, for example, the contents of the voice may mean “no voice input”, “normal voice” or “too noisy environment” in letter;
(506) using the sound amplifying unit 26 to play voices so as to offer interactive guidance to users and make them know the voice input status and adjust the volume for fulfillment of voice command operations in a real-time way.

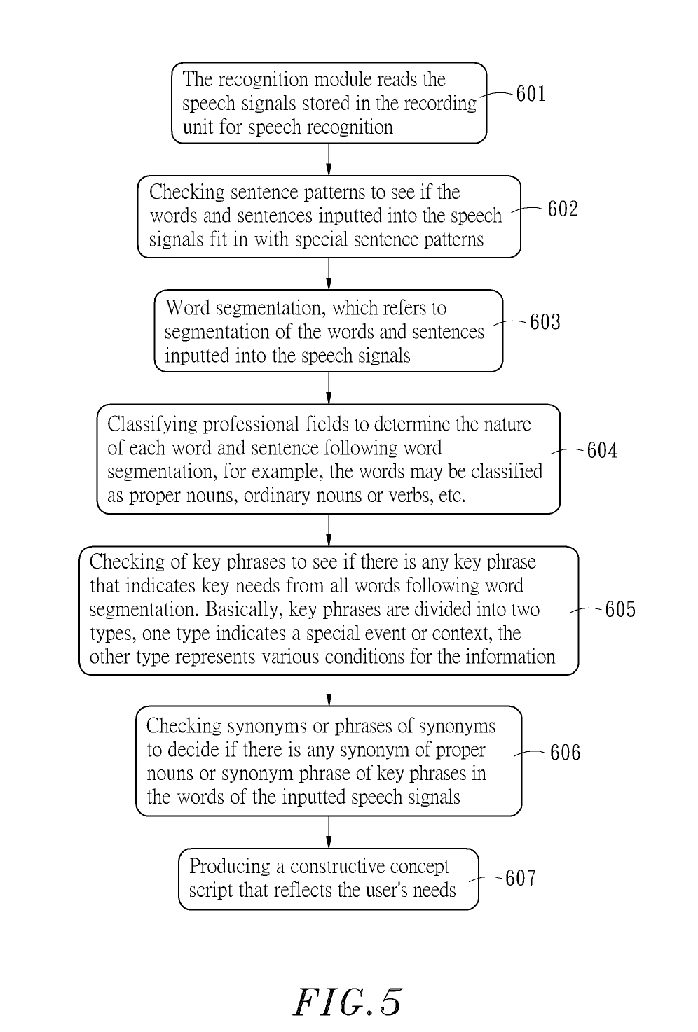

As shown clearly in the above-mentioned steps, the speech recognition device 2 of the present invention is connected through the plug interface 23 to the voice input unit 3 (microphone or ear microphone), and when users' voices are inputted as speech signals of voice control through the voice input unit 3, these signals can be acquired and stored by the recording unit 24, converted by the microprocessor 21 into a volume indication oscillograph, and then displayed by the display module 28. At the same time, the microprocessor 21 will decide if these signals satisfy the speech recognition conditions? (For example, the environment at time of voice input and voice input status, etc) if so, the recognition module 27 will be used to read the speech signals stored in the recording unit 24 for the purpose of speech recognition and analysis (as shown in FIGS. 5˜6), and the microprocessor 21 will read the speech signals stored in the storage module 11 in advance through the connecting interface 22 and transmission interface 12, and deliver these signals to the sound amplifying unit 26 for playing; if not, the indicating module 25 will read the speech signals stored in the recording unit 24 and conduct marking and voice indication on the coordinate axes where the volume indication oscillograph is located, wherein the marking may be done with graphs, letters or colors. Among them, graphs are used for indicating waveforms according to the volume indication oscillograph. For example, the waveform of a straight line implies no signal, meaning that something is wrong with the voice input unit 3 and no speech signal cannot be inputted as a result; or that the environment is so quiet that no sound is received; waveform segments indicate successful recognition of voice waves and execution of voice commands, or indicates unsuccessful recognition of voice waves, which requires follow-up interactive guidance; explosive waveforms indicate too high volume of and excessive gains for the voice input unit 3, or indicate that the user speaks in close proximity to the voice input unit 3; fine vibration waveforms show that the volume of the voice input unit 3 is too low, or that the user is far away from the voice input unit 3, resulting in poor voice acquisition; continuous vibration waveforms indicate that something is wrong with the sound amplifying unit 26, or that the environment is too noisy for the voice input unit 3 to distinguish voice waves from the mixture of sounds. Moreover, letters are used to describe the nature of each waveform following graphical indications. On the coordinate axes where various graphs are located, for example, corresponding descriptions may be given, such as “no voice input”, “normal voice”, “too high volume”, “too low volume” or “noisy environment”, etc.; and different colors can be used to distinguish and categorize the nature of each waveform, for example, the green color is used to indicate normal voices and the red color is used to indicate too high volume, etc. Besides, voice indication refers to use of voice commands for indicating the nature of each waveform. For example, the contents of the voice that corresponds with the descriptions in letter may be played by the sound amplifying unit 26 as “no voice input”, “normal voice” or “too noisy environment” etc. In this way, it will enable users to be aware of the input status and adjust the volume to fulfill voice command operations virtually in a timely manner with support of voice command operation indications, graphs, descriptions in letters and other interactive guidance, together with the volume indication oscillograph for conversion of speech signals, avoiding the problems and disadvantages associated with low speech recognition rate or distortions caused by abnormality of microphones and poor speech acquisition, achieving the effect of simple and quick operation and further strengthening the overall functionality and effectiveness of this device.

Continue to refer to FIGS. 5˜6, which shows that the speech signals inputted through the voice input unit 3 in the present invention can be analyzed and recognized by using the recognition module 27, and the steps of operation comprise:
(601) the recognition module 27 reads the speech signals stored in the recording unit 24 for speech recognition;
(602) checking the sentence pattern to see if the words and sentences inputted into the speech signals fit in with special sentence patterns;
(603) word segmentation, which refers to segmentation of the words and sentences inputted into the speech signals;
(604) classifying professional fields to determine the nature of each word and sentence following word segmentation, for example, the words may be classified as proper nouns, ordinary nouns or verbs, etc;
(605) checking of key phrases to see if there is any key phrase that indicates key needs from all words following word segmentation. Basically, key phrases are divided into two types, one type indicates a special event or context, the other type represents various conditions for the information;
(606) checking synonyms or phrases of synonyms to decide if there is any synonym of proper nouns or synonym phrase of key phrases in the words of the inputted speech signals;
(607) producing a constructive concept script that represents the user's needs;

In addition, the recognition module 27 included in the present invention will produce a constructive concept script after analyzing the speech signals inputted, and compare it with other constructive concept scripts in the storage module 11 of the multimedia electronic product 1. The steps of operation include:
(701) searching for the same or similar constructive concept scripts in the storage module 11 of the multimedia electronic product 1;
(702) producing constructive concept scripts from speech signals, identifying professional words and then searching the libraries of the constructive concept scripts in the storage module 11 for these professional words;
(703) finding related key words or phrases in the storage module 11 by using the professional words that have been identified;
(704) finding all related events and conditions in the storage module 11 based on the key words or phrases that have been found;
(705) finding the constructive concept scripts of the highest similarity according to all related events and conditions that have been identified;
(706) playing over the sound amplifying unit 26 of the speech recognition device 2.

The multimedia electronic product 1 as stated above can store and record multiple speech signals into the storage module 11 inside in advance through the transmission interface 12, and conduct editing or classification of these speech signals by operating internal programs and systems through the HMI 13 (songs can be classified according to title, singer, volume and Chinese, Taiwanese or Foreign language, etc.). After the user's voices are inputted as speech signals containing selective items (selection of songs, recordings, name of singer, song title, name of volume and switching of songs, etc) through the voice input unit 3 (microphone or ear microphone) and stored via the recording unit 24, these signals will be recognized and analyzed by using the recognition module 27 to search and find the items that satisfy related conditions, and then the sound amplifying unit 26 will be started to play these signals. Or, the microprocessor 21 is used to perform switching and selection of songs, volume adjusting or other selections, etc, thus quickly implementing voice command operations of the speech signals stored in the storage module 11 of the multimedia electronic product 1. In such circumstances, it's not necessary for users to press or touch buttons with their fingers to carry out more switches and selections, thus avoiding undesired touching or choices to be made and improving the convenience and accuracy in operation. Besides, the transmission interface 12 of the multimedia electronic product 1 and connecting interface 22 as well as the plug interface 23 of the speech recognition device 2 may be USB (Universal Serial Bus), SATA (Serial Advanced Technology Attachment) or eSATA (Serial Advanced Technology Attachment) interfaces used to transmit speech signals. It is stated that all steps and methods that can achieve the effects as indicated above should be included in the patent claims of the present invention, and that all other equivalent changes and modifications made without departing from the spirit of the art disclosed in the present invention should be included in the appended claims of the present invention.

To sum up all above descriptions, the indicating method for speech recognition system disclosed in the present invention, when applied, can really achieve its functions and utility. Therefore, the present invention is really an excellent invention with practical applicability, and can satisfy conditions for patentability of a utility model. While the application of patent is filed pursuant to applicable laws, your early approval of the present invention will be highly appreciated so as to guarantee benefits and rights of the inventor who has worked hard at this invention. For any question, please do not hesitate to inform the inventor by mail, and the inventor will try his best to cooperate with you.

What the invention claimed is:

1. An indicating method for speech recognition system, comprising a multimedia electronic product and a speech recognition device, wherein the steps for operation include:
(a1) the speech recognition device achieves input of speech signals through a voice input unit connected with a plug interface;
(a2) using a recording unit to acquire and store the speech signals;
(a3) a microprocessor reads the speech signals stored in the recording unit and converts these signals into a volume indication oscillograph, followed by display of these signals by a display module;
(a4) the microprocessor decides if the speech recognition conditions are met? If not, proceed to step (a5); if so, proceed to step (a6)
(a5) using an indicating module to read the speech signals stored in the recording unit for volume indication and repeat the step (a1);
(a6) using a recognition module to read the speech signals stored in the recording unit for speech recognition and analysis;
(a7) using the microprocessor to read the speech signals originally stored in a storage module inside the multimedia electronic product through a connecting and transmission interfaces;
(a8) playing the speech signals processed by the microprocessor over a sound amplifying unit.

2. The indicating method for speech recognition system according to claim 1, wherein the speech signals depend on the indicating module for volume indication in step (a5). Its steps include:
(b1) the indicating module accomplishes marking with graphs, letters or colors and voice indication on the axes where the volume indication oscillograph exists;
(b2) graphs are used for waveform indication according to the volume indication oscillograph, where the waveforms may be a straight line or take the form of waveform segments, explosive waveforms, fine vibration waveforms or continuous vibration waveforms, etc.;
(b3) letters are used to describe the nature of each waveform following graphical indication, and the descriptions may be “no voice input”, “normal voice”, “too high volume”, “too low volume” or “too noisy environment”, etc;
(b4) colors are used to distinguish and categorize the attributes of each waveform, for example, the green color is used to indicate normal voices and red color is used to indicate too loud voices;
(b5) voice indication refers to use of voice commands for indicating the nature of each waveform, and the contents of the voice may mean “no voice input”, “normal voice” or “too noisy environment” in letter;
(b6) play the speech signals over the sound amplifying unit to so as to offer interactive guidance to users and allow them to know the voice input status and adjust the volume for fulfillment of voice command operations in a real-time way.

3. The indicating method for speech recognition system according to claim 1, wherein the steps for analysis of speech signals through the recognition module in step (a6) comprise:
(c1) checking sentence pattern to see if the words and sentences inputted into speech signals fit in with special sentence patterns;
(c2) word segmentation, which refers to segmentation of the words and sentences inputted into the speech signals;
(c3) classifying professional fields to determine the nature of each word following word segmentation, where the words may be classified as proper nouns, ordinary nouns or verbs, etc;
(c4) checking key phrases to see if there is any key phrase that indicates key needs from all words following word segmentation; Basically, key phrases are divided into two types, one type indicates a special event or context, the other type represents various conditions for the information;
(c5) checking synonyms or phrases of synonyms to decide if there is any synonym of proper nouns or synonym phrase of key phrases in the words that are inputted into the speech signals;
(c6) producing a constructive concept script that represents the user's needs;
(c7) reading the speech signals that accord with the constructive concept scripts in the storage module of the multimedia electronic product by using the microprocessor;
(c8) playing the speech signals over the sound amplifying unit of the speech recognition device.

4. The indicating method for speech recognition system according to claim 3, wherein the steps for comparison of the constructive concept scripts include:
(d1) searching for the same or similar constructive concept scripts in the storage module of the multimedia electronic product;
(d2) deriving constructive concept scripts from the speech signals, identifying professional words in them and then searching libraries of professional words of the constructive concept scripts in the storage module with these professional words;
(d3) finding related key words or phrases in the storage module by using the professional words that have been identified;
(d4) finding all related events and conditions in the storage module based on the key words or phrases that have been found;
(d5) finding the constructive concept scripts of the highest similarity according to all related events and conditions that have been identified;
(d6) playing over the sound amplifying unit.

5. The indicating method for speech recognition system according to claim 1, wherein the multimedia electronic product is linked via the transmission interface with the connecting interface of the speech recognition device, while the microprocessor of the speech recognition device can read the speech signals stored in the storage module in advance by using the connecting and transmission interfaces; The transmission interface of the multimedia electronic product, connecting and plug interfaces of the speech recognition device may be USB, SATA, eSATA, etc.

6. The indicating method for speech recognition system according to claim 1, wherein the multimedia electronic product includes an HMI which is able to execute internal programs and edit and store signals, and the speech recognition device contains a microprocessor to read, select, switch or edit the speech signals stored in the storage module of the multimedia electronic product, where the speech signals may be songs, music or recordings, etc.

7. The indicating method for speech recognition system according to claim 1, wherein the voice input unit may be a microphone, ear microphone or other input unit that enables users to enter voices as voice commands and convert these voices into speech signals.
